(19) United States
(12) Patent Application Publication
(10) Pub. No.: US 2025/0141039 A1
(43) Pub. Date: May 1, 2025

(54) BATTERY VENT PROTECTOR

(71) Applicant: EaglePicher Technologies, LLC, Joplin, MO (US)

(72) Inventors: Kevin NOLTE, Joplin, MO (US); Rhonda SHIELDS, Joplin, MO (US); Garrett FRENCH, Joplin, MO (US); Dacota MARIS, Joplin, MO (US); Mark E. SMITH, Joplin, MO (US)

(21) Appl. No.: 18/686,728

(22) PCT Filed: Aug. 22, 2022
(86) PCT No.: PCT/US2022/041006

§ 371 Date: Feb. 26, 2024

Related U.S. Application Data
(60) Provisional application No. 63/240,110, filed on Sep. 2, 2021.

(51) Int. Cl. H01M 50/30; H01M 50/367

(52) U.S. Cl. CPC H01M 50/394; H01M 50/367

(57) ABSTRACT

A venting system for a battery includes a venting material disposed proximate to each cell of a plurality of electrochemical cells of the battery, the venting material configured to allow materials ejected due to a thermal event to flow through the venting material. The system also includes a venting device disposed in a fixed position relative to the venting material and the plurality of cells, the venting device including a structure for each cell. The structure includes a wall surrounding an area corresponding to a respective cell and extending away from the respective cell, the wall defining a venting path configured to direct ejected materials away from the respective cell.

### CROSS REFERENCE TO RELATED APPLICATIONS

This application claims the benefit of U.S. Application No. 63/240,110 filed Sep. 2, 2021, which is incorporated herein by reference in its entirety.

### BACKGROUND

Electrochemical cells are used as power sources in various devices and applications. Such cells are utilized as battery packs for supplying power to, e.g., electronics, electric vehicles, land vehicles, aircraft and/or marine vessels. These cells are commonly used in packs in which multiple cells are packed in close proximity, in order to achieve high energy density and small size. Due to the closeness of the cells to one another, if a cell emits hot gases and materials (e.g., due to internal short, thermal runaway or other event), this can cause damage to adjacent cells. It would be desirable to provide improved designs for cell assemblies or packs that provide protection from damage and prevent thermal runaway of a cell from damaging other cells and potentially causing a cascading failure.

### SUMMARY

An embodiment of a venting system for a battery includes a venting material disposed proximate to each cell of a plurality of electrochemical cells of the battery, the venting material configured to allow materials ejected due to a thermal event to flow through the venting material. The system also includes a venting device disposed in a fixed position relative to the venting material and the plurality of cells, the venting device including a structure for each cell. The structure includes a wall surrounding an area corresponding to a respective cell and extending away from the respective cell, the wall defining a venting path configured to direct ejected materials away from the respective cell.

An embodiment of a battery includes a plurality of electrochemical cells disposed in a cell housing, and a venting system including a venting material disposed proximate to each cell of a plurality of electrochemical cells of the battery, the venting material configured to allow materials ejected due to a thermal event to flow through the venting material. The venting system also includes a venting device disposed in a fixed position relative to the venting material and the plurality of cells, the venting device including a structure for each cell. The structure includes a wall surrounding an area corresponding to a respective cell and extending away from the respective cell, the wall defining a venting path configured to direct ejected materials away from the respective cell.

An embodiment of a method includes operating a battery that includes a plurality of electrochemical cells disposed in a cell housing, the battery including a venting system. The venting system includes a venting material disposed proximate to each cell of a plurality of electrochemical cells of the battery, and a venting device disposed in a fixed position relative to the venting material and the plurality of cells, the venting device including a structure for each cell. The structure includes a wall surrounding an area corresponding to a respective cell and extending away from the respective cell, the wall defining a venting path configured to direct ejected materials away from the respective cell. The method also includes, based on a thermal event occurring in an affected cell, allowing materials ejected from the affected cell to flow through the venting material and directing the ejected materials away from the affected cell along the venting path by the wall associated with the affected cell.

### BRIEF DESCRIPTION OF THE DRAWINGS

FIG. 1 depicts aspects of a battery assembly including a plurality of individual electrochemical cells, and components for venting ejected materials and heat; and

FIG. 2 is a cross-sectional view of an individual electrochemical cell of the assembly of FIG. 1; and

FIGS. 3A and 3B depict aspects of a battery assembly

FIGS. 4A and 4B depicts aspects of a battery assembly;

FIGS. 5A and 5B depict aspects of the battery assembly of FIGS. 4A and 4B;

FIG. 6 depicts aspects of a battery assembly including a venting material and a venting device;

FIG. 7 depicts aspects of a battery assembly; and

FIG. 8 is a graph representing an example of a thermal event.

### DETAILED DESCRIPTION

Inventive aspects of the disclosure are explained in detail below with reference to the various drawing figures. Examples are described to illustrate the disclosed subject matter, not to limit its scope. Those of ordinary skill in the art will recognize a number of equivalent variations of the various features provided in the description that follows.

The present disclosure relates to an electrochemical battery, such as a cell assembly having components configured to vent ejected materials. “Ejected materials” include particulates (e.g., smoke, conductive particles and/or other particles or matter ejected from a cell), fluids (e.g., liquids and gases) and/or other material that can be emitted from a cell. In an aspect, the venting components are configured to allow materials ejected from a venting cell to be directed away from the venting cell and away from other cells of a cell assembly, e.g., in response to a thermal or other event, and to avoid propagation to other cells in a battery or assembly of cells. The event may be related to internal failure of a cell, physical damage, over charging, heat build-up, or any other instance that causes the cell to vent. It is noted that the disclosed cell assemblies and components thereof are not limited to any particular type of cell, as aspects may be used with a variety of types of electrochemical cells, such as nickel metal hydride cells, nickel cadmium cells, silver zinc cells, or lithium ion cells. Also, the cells may have any suitable configuration, size, or shape. For example, the cells may be cylindrical, prismatic or pouch cells.

An aspect of a battery includes a plurality of individual electrochemical cells (e.g., such as lithium ion cells), and also includes a venting system having venting components that allow venting and provide a venting path for any material that may be ejected from a cell. In an aspect, the vent protection components includes a “venting material” disposed above each individual cell, or otherwise disposed proximate to each individual cell so that material ejected from a cell will pass through the venting material. The venting material is configured to open above a cell or otherwise allow ejected materials from the to pass through, while being resilient enough and/or restrained, such that venting material in adjacent cells does not open. A “proximate” position of a venting material relative to a cell is a position in which a portion of the venting material is in a venting path defined by the venting component for the cell. The venting material may have a permeable structure to allow ejected material to easily pass therethrough, and/or may be configured to break, tear or otherwise open due to the ejected material by either physical or chemical means. For example, the venting material may break to provide a vent path for the ejected material, or may melt when present with hot gases evolving from a cell. The venting material may be openable or breakable by ejected materials, or a permeable material that allows ejected materials to pass through. In an aspect, the venting material is an electrically insulating material.

Venting components may also include a venting device that is disposed in a fixed position relative to the venting material. In an aspect, the venting device defines at least part of a venting path that directs ejected material away from the cell and toward an exterior of the assembly (e.g., a battery case vent or other desired location). The venting path allows ejected materials and energy to be vented without damage to other cells in the assembly. In an embodiment, the venting device includes a structure that surrounds an area corresponding to a cell and forces ejected material and energy to a vent area above the cells, and also limits the size of an opening (e.g., hole or tear) so that the opening does not migrate to areas above other cells. As discussed further below, the venting device may also serve to prevent gases or other materials from traveling under the venting material to adjacent cells.

The venting material and the venting device may be positioned and secured in place in any suitable manner. For example, the venting material is secured to the cell assembly and/or the venting device via a mechanical fastener or adhered using an adhesive. In an aspect, the venting device is configured as a clamping or securing device (which may be a single device or multiple individual components) configured to secure the venting material in place relative to each cell, without interfering with the venting paths for each individual cell.

Aspects of electrochemical cells and cell assemblies described herein present a number of advantages and address a number of problems. Multi-cell battery packs are becoming increasingly common to achieve the voltage and capacity needs of electronic devices. Multi-cell packs find use in various applications, such as automotive, aviation, defense, spaceflight, grid energy storage, and others. The cells may be packaged in close proximity to each other to obtain high energy density, which can present some safety concerns. For example, during a thermal runaway event, material (e.g., particulates and gases) may be ejected from a cell. Due to the close proximity of the cells and compact packaging, the ejected material may be kept in close proximity to adjacent cells, causing the potential for shorting and propagation to one or multiple cells during the thermal runaway event.

A battery may include an electronic management system to electrically govern cell operation. However, such a system may not be able to respond effectively in instances such as internal cell failure causing thermal runaway or cell venting that can happen with little indication.

Aspects described herein provide a passive system to limit damage to the battery, cell assemblies, or a device in which the battery is installed. Aspects provide for a venting path for ejected materials and gases that effectively diverts the material and gases away from a cell, while providing protection for other cells in a cell pack. The venting path for the ejected materials can be kept relatively small to maintain the highest feasible energy density for a cell assembly.

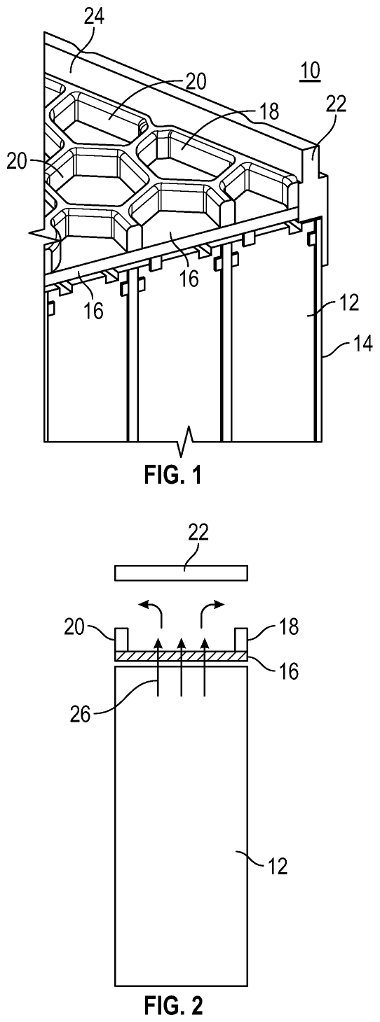

FIG. 1 is a cross-sectional view of a portion of an electrochemical cell assembly 10, which includes a plurality of individual electrochemical cells 12 electrically connected in series and parallel to achieve a desired voltage and capacity. In an aspect, the electrochemical cells 12 are lithium-ion cells, but may be any other suitable type of cell. For example, the assembly 10 is a battery pack that includes a plurality of cylindrical lithium-ion cells.

The assembly 10 includes a housing 14 in which the cells 12 are packed together, and as shown, the cells may be oriented in the same direction and in close proximity to one another. A “close proximity” may be a distance between adjacent cells of about 1-100 mm, 2 mm-90 mm, 5 mm-100 mm or any suitable combination of the upper and lower bounds of the aforementioned distances. For example, the cells 12 are separated by about 0.5 mm to about 10 mm. Each cell 12 is covered by a venting material 16 that is configured to provide electrical and thermal insulation and also to allow a venting path for materials and gases ejected from the cell 12 in the case of an event that causes the cell to emit gasses and/or solid material. An example of such an event is thermal runaway. Thermal runaway can occur for various reasons, such as internal failure of the cell, abuse from overcharging or discharging, physical damage, and excessive heat build-up.

In an aspect, the venting material 16 is a porous, heat resistant insulating material that is configured to allow ejected material to pass therethrough. The venting material is selected to be heat resistant, and in addition to allowing ejection from a given cell 12, also provides a layer of protection to cells 12 adjacent or proximate to a venting path.

The venting material 16 may allow ejected materials to pass through passageways within the material, and/or may allow the ejected materials to pass through by breaking, bursting or otherwise opening due to the force of the cell venting.

The venting material 16 also has sufficient modulus, substantiality, or robustness to maintain its integrity at cells 12 other than the venting cell 12. The venting material may be woven or non-woven material, and may comprise ceramic or glass fibers. For example, the venting material 16 can be a loosely woven or non-woven material such as a ceramic, a porous or permeable high-temperature plastic (e.g., plastic resistant to temperatures above about 300 degrees C., although lower temperature plastics may be used), woven fibers, foam, or a heat resistant paper material. Generally, the venting material 16 is selected to have properties that make the material resilient to high surface temperatures (e.g., about 600 degrees C. to about 1200 degrees C.). The venting material 16 is not so limited and may include any type of material or combination of materials that can easily allow gases and other materials ejected from a cell 12 to pass therethrough. Examples of venting materials include ceramic fiber papers, aramid fiber material, polymer films, polyamide polymers, aerogel laminates, mesh filters and others.

FIG. 1 shows an example of the venting material 16, which is provided as a sheet of venting material (e.g., woven material or temperature resistant paper) that covers each of the cells 12. The venting material 16 may be an integral component, such as single sheet as shown, or may be configured as individual sections of material above each cell 12. The sheet of venting material 16 may be a single layer of material, multiple layers of a material, or include multiple layers of different materials. The venting material 16 is loosely woven or otherwise configured to define passageways or openings to allow ejected materials to easily pass through, while maintaining a layer of protection from heat and debris for the other cells 12. Alternatively, or in addition, the venting material 16 may burst (e.g., via die cut “burst disk” areas) or break due to ejections from a cell, while remaining intact at other cells.

Although a single layer is shown in FIG. 1, it is to be understood that multiple layers or combinations of venting materials (e.g., the same or different materials) may be used. Venting materials may include any type of suitable material that is resistant to high temperatures (e.g., thermal runaway temperatures), and can be configured to provide a venting path. Examples include temperature resistant and non-flammable paper, refractory wool, ceramic materials, high temperature plastics, various types of lightweight, fibrous, high-temperature materials, and others.

In an aspect, the venting material 16 is maintained in close contact with, or in proximity to, each cell, to prevent any ejected material from following an undesired path. For example, the close contact or proximity prevents ejected materials from flowing under the venting material 16 and bypassing the desired venting path.

Various materials and/or mechanisms may be used to secure the venting material 16 in place. Examples include adhesives and high temperature insulating tapes, either in combination with a clamping device or as an alternative to a clamping device.

In an aspect, the cell assembly 10 includes a venting device 18 that is configured to provide vent paths for ejected materials, and may be configured to maintain the venting material 16 in a fixed position relative to the cells 12 (e.g., by clamping the venting material 16 to the cells 12 and/or housing 14). The venting device 18 may also define all or part of a venting path away from an ejecting cell 12. The venting path allows ejected materials to be vented without damage to other cells in the assembly. The venting device 18 may be a single integrated body or structure, or may be include multiple components or structures.

FIG. 1 depicts an example of a venting device 18, which is a single integral component that defines individual structures, in which each structure forms part of a venting path away from a respective cell 12. In this example, the venting device 18 is a flat honeycomb structure that defines a hexagonal (or partly hexagonal) structure 20 that surrounds an area above each cell 12 (a “venting area”). Each structure 20 defines walls that extend vertically away from the top of a respective cell 12 and associated venting area. It is noted that “vertical” in this example refers to a direction parallel to a longitudinal axis of a cell 12. The structures 20 may provide an arduous path for the venting material to be adequately cooled prior to impacting adjacent cells, thus any number or type of openings, channels, grooves, conduits (e.g., tubing) and/or other configurations may be used.

The venting device 18 may be secured to the housing 14 and venting material 16 in any suitable manner. For example, the venting device 18 can be adhered to or secured (e.g., via screws or other mechanical securing mechanism) to a cover 22, which is in turn secured to the body 14. The cover 22, as shown in FIG. 1, may define side walls 24 that extend vertically to provide a gap or volume above the venting device 18. A cover or other feature may be included to extend horizontally above the venting device 18, in order to define part of the venting path. “Horizontal” in this example refers to a direction in a plane perpendicular to the cell longitudinal axes. The venting device 18 may form all or part of a clamping mechanism that secures the venting material 16 in place, or the venting material 16 may be secured in place via a different securing mechanism.

FIG. 2 is a cross-section of an individual cell 12 and a portion of the assembly 10, which illustrates an example of a venting path provided through the venting material 16 and defined at least by the venting device 18. The venting path is shown by arrows 26 that illustrate the flow of ejected materials. As shown, the venting path is vertical through the venting device 18 and then extends generally horizontally. A cover 22 is disposed at a selected vertical distance from the top of the venting device 18, and defines a “free area” above the venting device (and its associated venting area) that provides sufficient clearance from the cells 12 to avoid damage thereto. As an example, the side walls 24 can have a vertical extent of about 0.11 inches (or more or less), and a thickness of the free area (from the venting material 16 to the cover 22) can be about 0.3 inches (or more or less). As shown, ejected materials are ejected vertically through a device structure 20 and then are directed horizontally through the free area to a desired location, such as an exterior of the body 14 or a heat sink.

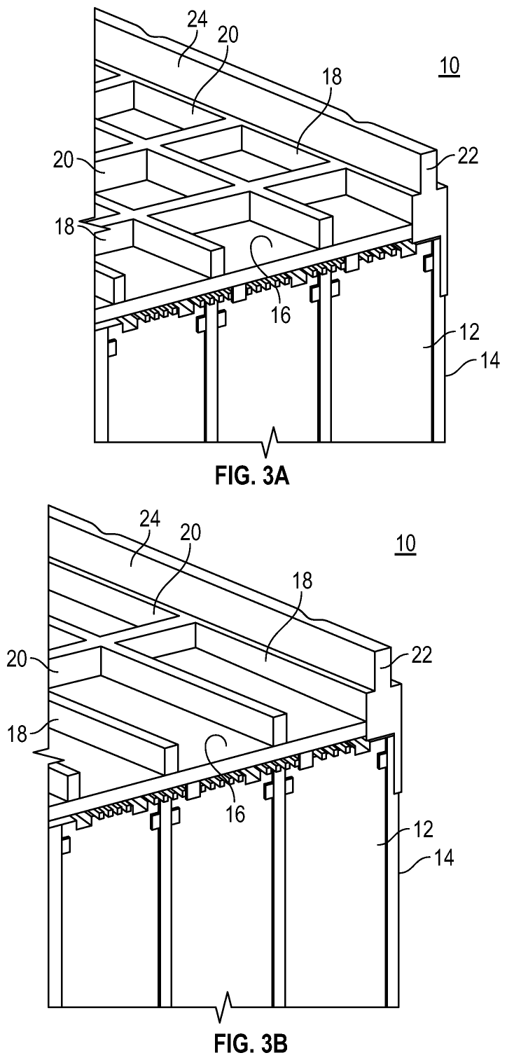

FIGS. 3A and 3B depict other examples of a venting device 18. In these examples, each cell 12 is a rectangular prismatic cell (having an approximately square shape as shown in FIG. 3A, or a more elongated rectangular shape as shown in FIG. 3B), and the venting device 18 defines individual structures 20 that surround a rectangular area above each cell. The venting path in this example is a vertical path through each venting area that extends to a free area above the venting device 18. Ejected materials from a given cell 12 can thus flow vertically to the free area and subsequently flow horizontally or in any suitable direction.

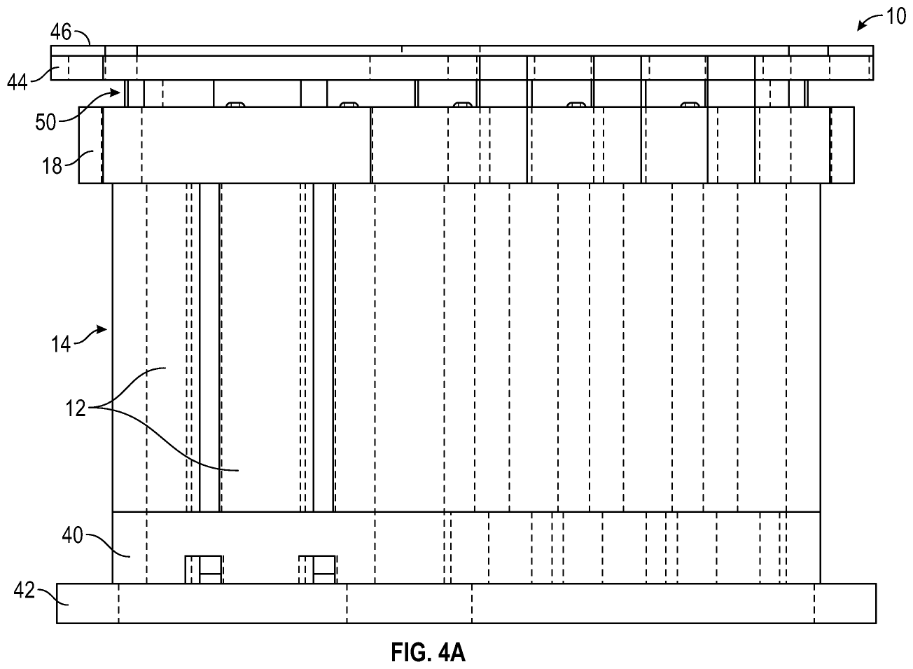

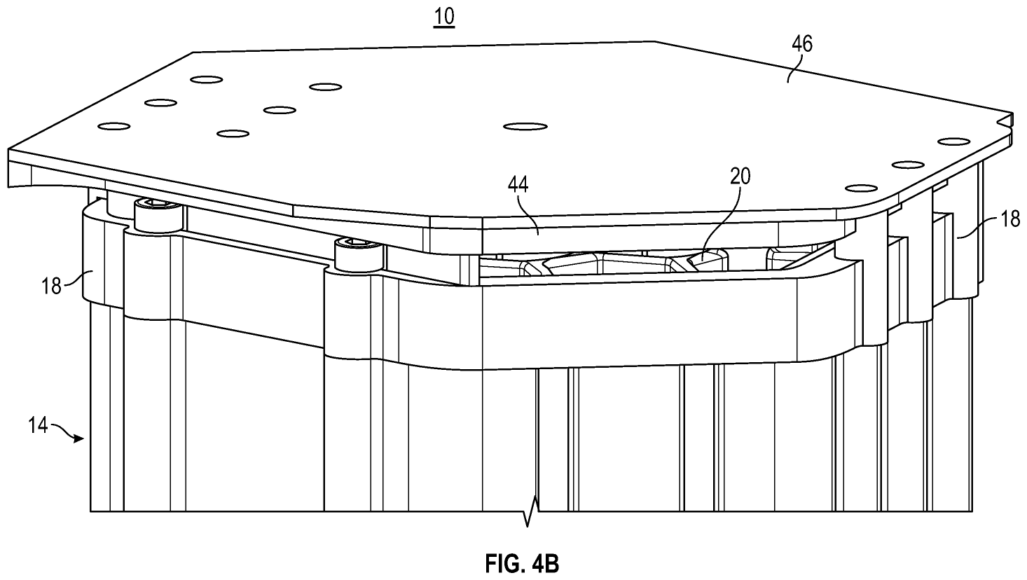

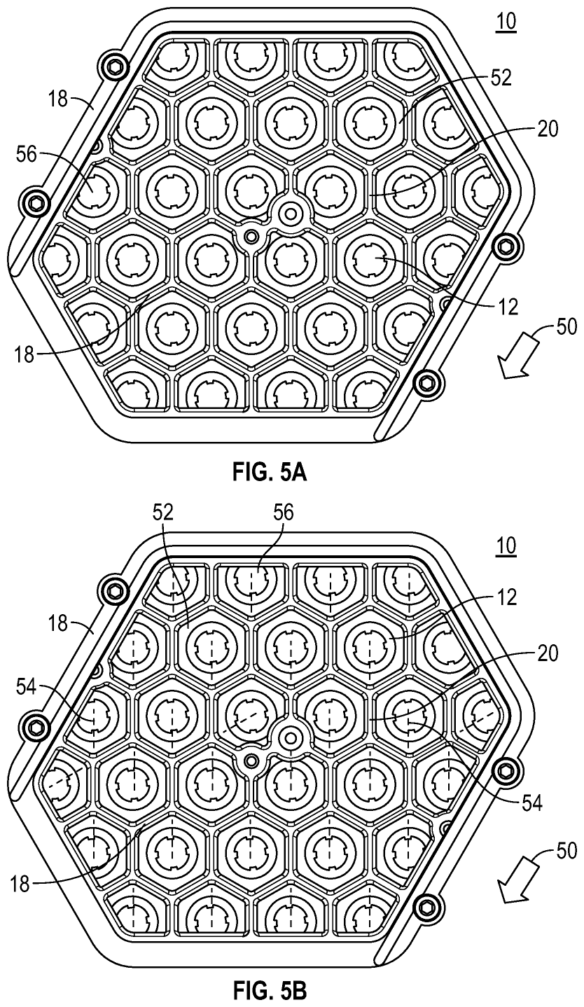

FIGS. 4A, 4B, 5A and 5B depict an embodiment of the electrochemical cell assembly 10 including the plurality of cells 12. The cells 12 in this embodiment are cylindrical lithium-ion cells, however the embodiment is not so limited. The cell assembly 10 may include an enclosure (not shown) that is electrically isolated from the cells 12 and may be made from any desired material (e.g., steel, aluminum or other thermally conductive material). The enclosure and/or other parts of the cell assembly 10 function as a heat sink to assist in temperature regulation.

FIG. 4A is a cross-sectional view of the cell assembly 10, and FIG. 4B is a perspective view of a portion of the cell assembly 10. The housing 14 is disposed on a heat sink 40 that is mounted on a mounting plate 42. The venting device 18 and the venting material 16 are disposed between the housing 14 and an insulation layer 44. The insulation layer 44 isolates the cells 12 from a protected component 46 (e.g., a PCB, battery case, etc.).

The venting material 16 is disposed above the plurality of cells 12, and may be made from a material that opens (e.g., breaks or bursts) or a material that is permeable to materials that may be ejected from a cell during thermal runaway or other thermal event.

The venting device 18, in an embodiment, maintains the venting material 16 in a fixed position relative to the cells 12. In this embodiment, the venting device 18 is a body that defines individual structures 20 having walls that establish vertical pathways for ejected materials to flow away from an ejecting cell 12 and other cells 12. The venting device 18 is held in place via mechanical fasteners such as bolts or any other suitable mechanism. In this way, a venting path is established that includes vertical pathways for each structure that extend away from a respective cell 12. For example, FIG. 4A shows part of venting path that includes a generally horizontal pathway 50 established in a gap or space between the venting device 18 and the insulating material 44.

FIGS. 5A and 5B are top cross-sectional views of embodiments of the cell assembly 10, which show aspects of venting paths defined by a suitable enclosure, casing or other structure, and individual venting structures 20 defined by the venting device 18. FIGS. 5A and 5B also show a conductor 52 in electrical communication with positive terminals 56 of the cells 12. FIG. 5B shows an embodiment in which the positive terminals 56 are connected in parallel to the conductor 52 via wire bonds 54.

As shown, each structure 20 forms a hexagonal wall around a space directly above a respective cell 12 that defines a vertical path for ejected materials and energy. The vertical paths terminate in a cavity (e.g., the space between the venting device 18 and the insulating material 44 as shown in FIG. 4A) that directs ejected materials along a horizontal path 50 above and around a periphery of the cells 12 to a safe location in the assembly and/or to an external location (e.g., via a battery case vent.

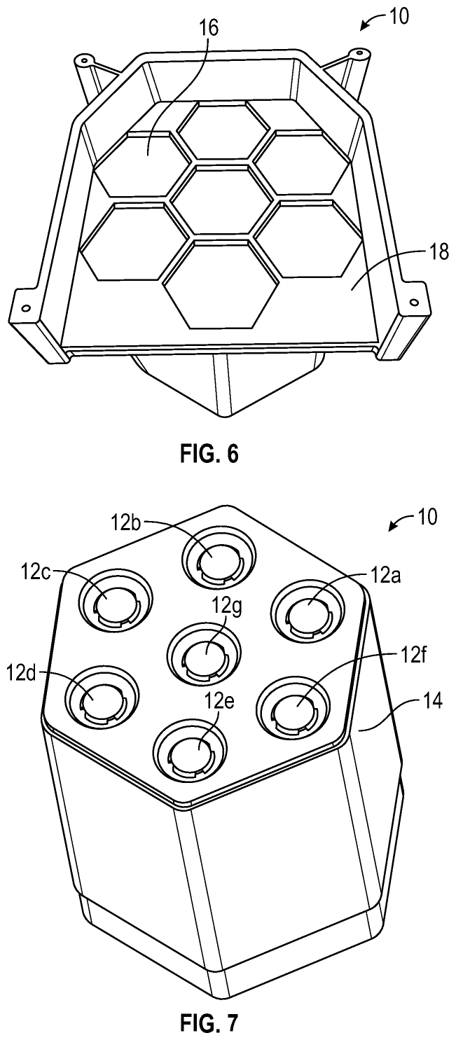

FIGS. 6-8 depict an embodiment of the cell assembly 10 and illustrate effects of the venting material 16 and the venting device 18 on a thermal event. As shown in FIG. 6, the cell assembly 10 includes a venting material 16 in the form of a heat resistant paper, and a venting device 18 defining a hexagonal vent path above each cell. As shown in FIG. 7, the cell assembly 10 include a plurality of cells 12, denoted as cells 12a-g

In this example, an internal short circuit was induced in the centrally located cell 12g, causing thermal runaway. The temperature of each cell 12a-12g was measured prior to and during the thermal runaway event.

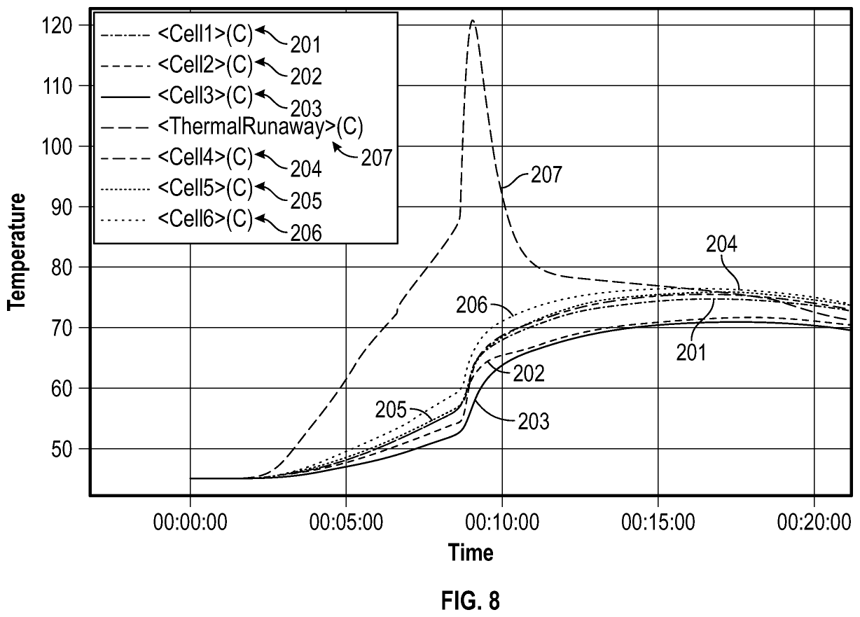

FIG. 8 depicts the temperature of each cell over a time period corresponding to the event. FIG. 8 shows a graph of temperature (in Celsius) as a function of time. The temperature of cell 12a is represented by curve 201, the temperature of cell 12b is represented by curve 202, the temperature of cell 12c is represented by curve 203, and the temperature of cell 12d is represented by curve 204. The temperature of cell 12e is represented by curve 205, the temperature of cell 12e is represented by curve 206, and the temperature of cell 12g is represented by curve 207.

As shown, the temperature of cell 12g rises from an initial temperature of about 45 degrees C., and thermal runaway begins at an initiation temperature of about 88 degrees C. and subsequently rises sharply. However, the remaining cells are not significantly affected and maintain a maximum temperature that is less than the thermal runaway initiation temperature.

It is appreciated that the various components described herein may be made from any of a variety of materials including, for example, metal, copper, aluminum, stainless steel, nickel, titanium, plastic, plastic resin, nylon, composite material, glass, and/or ceramic, for example, or any other material as may be desired.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components that are otherwise not necessary to the achievement of the function or objectives of the compositions, methods, and articles.

“Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspect”, “an aspect”, and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination comprising at least one of the listed components or properties optionally together with a like or equivalent component or property not listed

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A venting system for a battery, comprising:
a venting material disposed proximate to each cell of a plurality of electrochemical cells of the battery, the venting material configured to allow materials ejected due to a thermal event to flow through the venting material; and
a venting device disposed in a fixed position relative to the venting material and the plurality of cells, the venting device including a structure for each cell, the structure including a wall surrounding an area corresponding to a respective cell and extending away from the respective cell, the wall defining a venting path configured to direct ejected materials away from the respective cell.

2. The venting system of claim 1, wherein each structure extends away from the plurality of electrochemical cells to a vent area.

3. The venting system of claim 1, wherein the venting material is electrically insulating and resistant to temperatures associated with the thermal event.

4. The venting system of claim 3, wherein the venting material is configured to open due to the ejected materials to provide the venting path.

5. The venting system of claim 3, wherein the venting material is permeable to the ejected materials.

6. The venting system of claim 1, wherein the venting device is configured to secure the venting material at the fixed position.

7. The venting system of claim 6, wherein the venting device is configured to clamp the venting material to a housing of the plurality of electrochemical cells by a clamping mechanism.

8. The venting system of claim 1, wherein the venting device is an integral component defining the structure for each cell.

9. A battery, comprising:
a plurality of electrochemical cells disposed in a cell housing; and
a venting system including:
a venting material disposed proximate to each cell of a plurality of electrochemical cells of the battery, the venting material configured to allow materials ejected due to a thermal event to flow through the venting material; and
a venting device disposed in a fixed position relative to the venting material and the plurality of cells, the venting device including a structure for each cell, the structure including a wall surrounding an area corresponding to a respective cell and extending away from the respective cell, the wall defining a venting path configured to direct ejected materials away from the respective cell.

10. The battery of claim 9, wherein each structure extends away from the plurality of electrochemical cells to a vent area.

11. The battery of claim 9, wherein the venting material is electrically insulating and resistant to temperatures associated with the thermal event.

12. The battery of claim 9, wherein the venting material is configured to open due to the ejected materials to provide the venting path.

13. The battery of claim 9, wherein the venting material is permeable to the ejected materials.

14. The battery of claim 9, wherein the venting path and the structure allows the ejected materials to be directed away from the respective cells without damaging other cells in the plurality of electrochemical cells.

15. The battery of claim 9, wherein the venting device is configured to clamp the venting material to the cell housing by a clamping mechanism, the clamping mechanism securing the venting material in the fixed position.

16. The battery of claim 9, wherein the venting device is an integral component defining the structure for each cell.

17. A method comprising:
operating a battery that includes a plurality of electrochemical cells disposed in a cell housing, the battery including a venting system, the venting system including:
a venting material disposed proximate to each cell of a plurality of electrochemical cells of the battery; and
a venting device disposed in a fixed position relative to the venting material and the plurality of cells, the venting device including a structure for each cell, the structure including a wall surrounding an area corresponding to a respective cell and extending away from the respective cell, the wall defining a venting path configured to direct ejected materials away from the respective cell; and
based on a thermal event occurring in an affected cell, allowing materials ejected from the affected cell to flow through the venting material and directing the ejected materials away from the affected cell along the venting path by the wall associated with the affected cell.

18. The method of claim 17, wherein the structure directs the ejected materials to a vent area.

19. The method of claim 17, wherein the venting material opens due to the ejected materials to provide the venting path.

20. The method of claim 17, wherein the ejected materials are directed away from the respective cells without damaging other cells in the plurality of electrochemical cells.
